(19) United States
(12) Patent Application Publication
(10) Pub. No.: US 2022/0113271 A1
(43) Pub. Date: Apr. 14, 2022

(54) GAS CONCENTRATION DETECTION METHOD, GAS CONCENTRATION DETECTION DEVICE, AND GAS GENERATION SYSTEM

(71) Applicant: YAMAHA FINE TECHNOLOGIES CO., LTD., Hamamatsu-shi (JP)

(72) Inventors: Takeshi KATO, Shimada-shi (JP); Tamito SUZUKI, Fukuroi-shi (JP); Hisashi ICHINOKIYAMA, Hamamatsu-shi (JP)

(21) Appl. No.: 17/557,619

(22) Filed: Dec. 21, 2021

Related U.S. Application Data
(63) Continuation of application No. PCT/JP2020/024861, filed on Jun. 24, 2020.

(30) Foreign Application Priority Data
Jun. 28, 2019 (JP) 2019-121351

(51) Int. Cl. G01N 27/16; C25B 1/04

(52) U.S. Cl. CPC G01N 27/16; C25B 1/04

(57) ABSTRACT

Hydrogen and oxygen are generated by water electrolysis. A catalytic combustion type gas sensor is arranged in at least one of a hydrogen path for recovering the hydrogen and an oxygen path for recovering the oxygen. An oxygen concentration in the hydrogen path or a hydrogen concentration in the oxygen path are detected by the catalytic combustion type gas sensor.

### CROSS-REFERENCE TO RELATED APPLICATIONS

The present application is a continuation application of International Application No. PCT/JP2020/024861, filed Jun. 24, 2020, which claims priority to Japanese Patent Application No. 2019-121351, filed Jun. 28, 2019. The contents of these applications are incorporated herein by reference.

### BACKGROUND OF THE INVENTION

### Field of the Invention

The present invention relates to a gas concentration detection method, a gas concentration detection device, and a gas generation system.

### Description of Related Art

Conventionally, there is a water electrolysis cell method that generates hydrogen and oxygen from water by using electrolysis of water. This system uses a water electrolysis cell in which a power feeding body is arranged on both sides of a structure in which electrode catalyst layers are provided on both sides of a solid polymer electrolyte membrane (ion exchange membrane). A voltage is applied to the water electrolysis cell, and water is supplied to the power feeding body on the anode side. As a result, water is electrolyzed on the anode side to generate hydrogen ions, and these hydrogen ions pass through the solid polymer electrolyte membrane and move to the cathode side, and bond with electrons at the cathode side power feeding body to generate hydrogen. On the anode side, oxygen is generated by the electrolysis of water.

In such a water electrolysis cell method, when the water electrolysis cell is damaged such that the solid polymer electrolyte membrane is torn or the like, oxygen generated on the anode side and high-concentration hydrogen generated on the cathode side may be mixed. When hydrogen and oxygen are mixed, the expected concentrations cannot be maintained. Therefore, it is desirable that the state of the water electrolysis cell be managed in the process of generating hydrogen and oxygen by the water electrolysis cell method.

### SUMMARY OF THE INVENTION

However, in order to inspect for damage to the water electrolysis cell, for example, in order to manage the damage of the water electrolysis cell, it is necessary to temporarily stop the electrolysis and check whether or not the water electrolysis cell is damaged. However, when the electrolysis is stopped, the generation of hydrogen and oxygen must be stopped. In addition, the burden of checking whether the water electrolysis cell is not damaged is great.

Therefore, the inventors have found that oxygen generated on the anode side leaks to the cathode side and that hydrogen generated on the cathode side leaks to the anode side due to damage to the water electrolysis cell. Further, it is preferable to be able to ascertain the concentration of hydrogen leaked to the anode side or the concentration of oxygen leaked to the cathode side in that the assumed concentration can be maintained.

The present invention was made in view of such a situation. An example of an object of the present invention is to provide a gas concentration detection method, a gas concentration detection device, and a gas generation system that can measure the concentration of hydrogen leaked into oxygen generated by using water electrolysis or the concentration of oxygen leaked into hydrogen generated by using water electrolysis.

One aspect of the present invention is a gas concentration detection method including: generating hydrogen and oxygen by water electrolysis; arranging a catalytic combustion type gas sensor in at least one of a hydrogen path for recovering the hydrogen and an oxygen path for recovering the oxygen; and detecting, by the catalytic combustion type gas sensor, an oxygen concentration in the hydrogen path or a hydrogen concentration in the oxygen path.

One aspect of the present invention is a gas concentration detection device including: a detection unit that detects, using a catalytic combustion type gas sensor, an oxygen concentration in a hydrogen path for recovering hydrogen generated using water electrolysis or a hydrogen concentration in an oxygen path for recovering oxygen generated using water electrolysis, the catalytic combustion type gas sensor being arranged in at least one of the hydrogen path and the oxygen path; and a sensor control unit that controls measurement of concentration by the catalytic combustion type gas sensor based on the detected oxygen concentration or the detected hydrogen concentration.

One aspect of the present invention is a gas generation system including: the above gas concentration detection device; a generation device that generates the hydrogen and the oxygen by water electrolysis, supplies the hydrogen to the hydrogen path, and supplies the oxygen to the oxygen path; and a management device that controls generation of hydrogen and oxygen by the generation device based on the detected oxygen concentration or the detected hydrogen concentration.

### BRIEF DESCRIPTION OF THE DRAWINGS

FIG. 1 is a block diagram showing a configuration example of a gas generation system 1 of an embodiment.

FIG. 2A is a schematic diagram illustrating a gas sensor using a semiconductor 50.

FIG. 2B is a diagram illustrating a detection method using the gas sensor shown in FIG. 2A.

FIG. 2C is a diagram illustrating a detection method using the gas sensor shown in FIG. 2A.

FIG. 3A is a diagram illustrating a detection method by a catalytic combustion type gas sensor 20 of the embodiment.

FIG. 3B is a diagram illustrating a detection method by the catalytic combustion type gas sensor 20 of the embodiment.

FIG. 4A is a diagram illustrating a detection method by the catalytic combustion type gas sensor 20 of the embodiment.

FIG. 4B is a diagram illustrating a detection method by the catalytic combustion type gas sensor 20 of the embodiment.

FIG. 5 is a block diagram showing a configuration example of a sensor unit 30 of the embodiment.

FIG. 6 is a sequence diagram illustrating the flow of processing performed by the gas generation system 1 of the embodiment.

### EMBODIMENTS FOR CARRYING OUT THE INVENTION

Hereinbelow, embodiments of the present invention will be described with reference to the drawings.

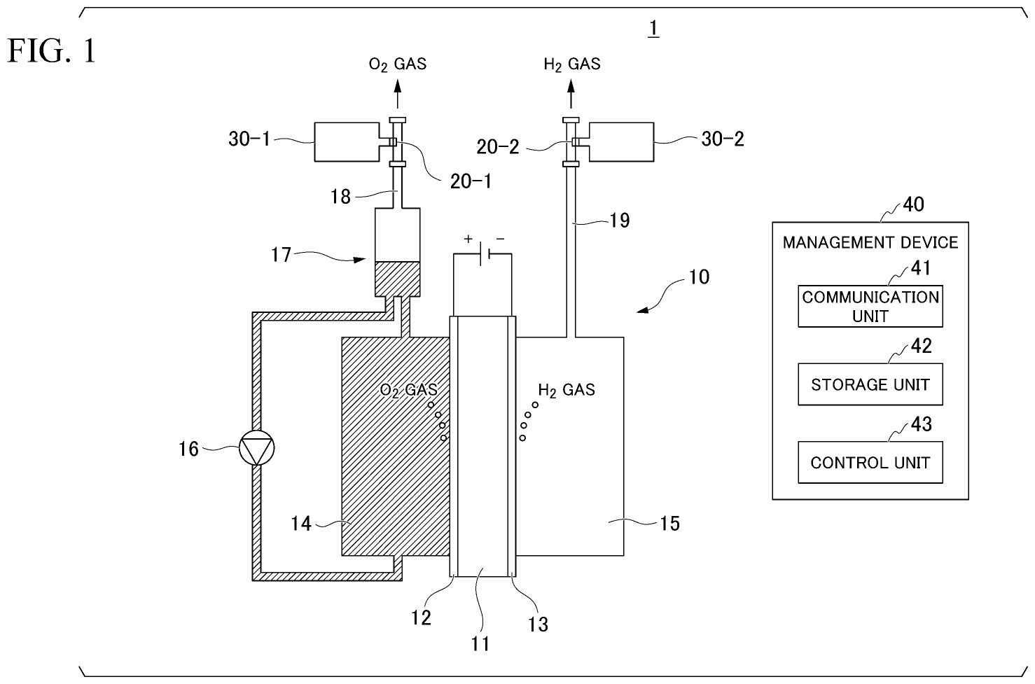

FIG. 1 is a block diagram showing a configuration example of a gas generation system 1 of the embodiment. The gas generation system 1 includes, for example, a water electrolysis cell 10, two catalytic combustion type gas sensors 20 (catalytic combustion type gas sensors 20-1 and 20-2), two sensor units 30 (sensor unit 30-1 and 30-2) and a management device 40. Here, the water electrolysis cell 10 is an example of a “generation device”. The sensor unit 30 is an example of a “gas concentration detection device”.

FIG. 1 illustrates the case where the gas generation system 1 including two catalytic combustion type gas sensors 20 and two sensor units 30. However, the embodiment of the present invention is not limited to such a configuration. It is sufficient that the gas generation system 1 includes at least one catalytic combustion type gas sensor 20 and at least one sensor unit 30 corresponding to the catalytic combustion type gas sensor 20.

The water electrolysis cell 10 is a device that generates oxygen and hydrogen by electrolyzing water (water electrolysis). The water electrolysis cell 10 includes, for example, a solid polymer electrolyte membrane 11, an anode-side electrode catalyst layer 12, a cathode-side electrode catalyst layer 13, an anode-side power feeding body 14, a cathode-side power feeding body 15, a water circulation pump 16, a gas-liquid separator 17, an oxygen path 18, and a hydrogen path 19.

The solid polymer electrolyte membrane 11 is an ion filtration membrane that allows only cations (here, hydrogen ions) to pass through. The anode-side electrode catalyst layer 12 is provided on one side (anode side) of the solid polymer electrolyte membrane 11, and the anode-side power feeding body 14 is further provided via the anode-side electrode catalyst layer 12. The cathode-side electrode catalyst layer 13 is provided on the other side (cathode side) of the solid polymer electrolyte membrane 11, and the cathode-side power feeding body 15 is further provided via the cathode-side electrode catalyst layer 13. The anode side and the cathode side are electrically connected via a power source. The anode-side power feeding body 14 is provided with the gas-liquid separator 17, and the oxygen path 18 is further provided via the gas-liquid separator 17. The cathode-side power feeding body 15 is provided with the hydrogen path 19. A pipe for recovering the oxygen generated by the water electrolysis cell 10 is arranged in the oxygen path 18. A pipe for recovering the hydrogen generated by the water electrolysis cell 10 is arranged in the hydrogen path 19.

The water electrolysis cell 10 generates oxygen and hydrogen under the control of the management device 40. When generating oxygen and hydrogen, the power supply is controlled to be energized, and a voltage is applied from the anode side to the cathode side of the solid polymer electrolyte membrane 11. In the water electrolysis cell 10, the water circulation pump 16 is driven to supply water to the anode-side power feeding body 14. As a result, the water in the anode-side power feeding body 14 is electrolyzed, and the anode-side electrode catalyst layer 12 and the cathode-side electrode catalyst layer 13 promote electrolysis. Hydrogen ions are generated in the anode-side power feeding body 14 by the electrolysis of water, and the hydrogen ions pass through the solid polymer electrolyte membrane 11 and move to the cathode-side power feeding body 15. The hydrogen ions that have moved to the cathode-side power feeding body 15 bond with electrons to become hydrogen. On the other hand, in the anode-side power feeding body 14, oxygen is generated by the electrolysis of water. The oxygen generated by the anode-side power feeding body 14 is separated from the water by the gas-liquid separator 17 and recovered through the oxygen path 18. The hydrogen generated by the cathode-side power feeding body 15 is recovered through the hydrogen path 19.

Here, the gas recovered from the anode-side power feeding body 14 through the oxygen path 18 contains a trace amount (for example, about 100 ppm) of hydrogen in a high concentration of oxygen when the water electrolysis cell 10 is not damaged. Further, the gas recovered from the cathode-side power feeding body 15 through the hydrogen path 19 contains a trace amount (for example, about 100 ppm) of oxygen in a high concentration of hydrogen when the water electrolysis cell 10 is not damaged. In the following description, the gas recovered through the oxygen path 18 is referred to as “oxygen atmosphere gas”. The gas recovered through the hydrogen path 19 is referred to as “hydrogen atmosphere gas”.

The catalytic combustion type gas sensor 20 measures the concentration of the gas to be detected (detection target gas). The catalytic combustion type gas sensor 20 includes, for example, a catalyst layer, a heater, and a thermopile. The catalyst layer acts as a catalyst when combusting the detection target gas. The heater heats the catalyst layer and promotes combustion. The thermopile is a temperature measuring element and outputs an electrical signal according to the amount of heat of combustion. That is, the catalytic combustion type gas sensor 20, by combusting the detection target gas contained in the atmosphere and electrically detecting the temperature rise due to the combustion heat, outputs an electrical signal according to the concentration of the detection target gas.

As the catalytic combustion type gas sensor 20, for example, the combustion gas sensor described in Japanese Patent No. 6467172 is used. In such a catalytic combustion type gas sensor, the lower limit of the hydrogen concentration that can be measured as an actual measurement is about 10 ppm. That is, the catalytic combustion type gas sensor 20 can detect the hydrogen concentration in a gas in which oxygen having a concentration of 99.999% or less and hydrogen having a concentration of 10 ppm or more are mixed. Further, in such a catalytic combustion type gas sensor, the upper limit of the hydrogen concentration that can be measured as an actual measurement is about 1%. That is, it is possible to detect the concentration of hydrogen in a gas in which oxygen having a concentration of 99% or more and hydrogen having a concentration of 1% or less are mixed.

Further, in such a catalytic combustion type gas sensor, the lower limit of the oxygen concentration that can be measured as an actual measurement is about 10 ppm. That is, it is possible to detect the concentration of oxygen in a gas in which hydrogen having a concentration of 99.999% or less and oxygen having a concentration of 10 ppm or more are mixed. Further, in such a catalytic combustion type gas sensor, the upper limit of the oxygen concentration that can be measured as an actual measurement is about 1%. That is, it is possible to detect the concentration of oxygen in a gas in which hydrogen having a concentration of 99% or more and oxygen having a concentration of 1% or less are mixed.

The catalytic combustion type gas sensor 20-1, which is arranged in the oxygen path 18, measures the concentration of hydrogen (hydrogen concentration) contained in the oxygen atmosphere gas in the oxygen path 18. The catalytic combustion type gas sensor 20-1 causes the hydrogen contained in the oxygen atmosphere gas to be reacted with the oxygen and electrically detects the temperature rise due to combustion heat (reaction heat) to thereby output an electrical signal corresponding to the hydrogen.

The catalytic combustion type gas sensor 20-2, which is arranged in the hydrogen path 19, measures the concentration of oxygen (oxygen concentration) in the hydrogen atmosphere gas in the hydrogen path 19. The catalytic combustion type gas sensor 20-2 causes the oxygen contained in the hydrogen atmosphere gas to be reacted with the hydrogen and electrically detects a temperature rise due to combustion heat (reaction heat) to thereby output an electrical signal corresponding to the oxygen concentration.

The sensor unit 30 controls the catalytic combustion type gas sensor 20. The sensor unit 30 starts or stops measurement by the catalytic combustion type gas sensor 20. The sensor unit 30 raises the temperature of the heater by for example supplying a drive current to the heater of the catalytic combustion type gas sensor 20. As a result, the measurement of the catalytic combustion type gas sensor 20 is started. The sensor unit 30 lowers the temperature of the heater by stopping the supply of the drive current to the heater of the catalytic combustion type gas sensor 20. Thereby, the measurement by the catalytic combustion type gas sensor 20 is stopped.

The sensor unit 30 controls the measurement by the catalytic combustion type gas sensor 20. For example, when the temperature of the catalytic combustion type gas sensor 20 exceeds a predetermined threshold value during measurement, the sensor unit 30 performs control to reduce the drive current supplied to the heater so that the temperature does not rise too much. Alternatively, the sensor unit 30 may perform control to stop the drive current supplied to the heater when the temperature of the catalytic combustion type gas sensor 20 exceeds a predetermined threshold value during measurement. The temperature of the catalytic combustion type gas sensor 20 is measured using, for example, a temperature sensor provided for measuring the temperature of the catalytic combustion type gas sensor 20. Alternatively, the temperature of the catalytic combustion type gas sensor 20 may be measured using the output of the thermopile.

The sensor unit 30 notifies the management device 40 of the measured value measured by the catalytic combustion type gas sensor 20. The measured values measured by the catalytic combustion type gas sensors 20 are the concentration of hydrogen contained in the oxygen atmosphere gas and the concentration of oxygen contained in the hydrogen atmosphere gas. The sensor unit 30 may notify the management device 40 of the temperature of the catalytic combustion type gas sensor 20.

The management device 40 controls the water electrolysis cell 10 and the sensor unit 30. The management device 40 includes a communication unit 41, a storage unit 42, and a control unit 43. The communication unit 41 communicates with the water electrolysis cell 10 and the sensor unit 30. The communication unit 41 is realized by, for example, a general-purpose communication IC (integrated circuit). The communication unit 41 has a function of communicating with an external network and transmitting/receiving information with the sensor unit 30 and the like. The storage unit 42 stores information on the concentration and temperature notified from the sensor unit 30. The storage unit 42 is, for example, a non-volatile memory, and stores a program for realizing the function of the management device 40 and various types of information.

The control unit 43 comprehensively controls the management device 40. The control unit 43 is composed of, for example, a CPU (central processing unit) included in the management device 40. The control unit 43 realizes the functions of each unit in the management device 40 by executing the program stored in the storage unit 42. More specifically, the control unit 43, which may be a processor, is configured to execute the instructions stored in the storage unit 42, which may be a memory, to realize the functions of the control unit 43. For example, the control unit 43 puts the power supply of the water electrolysis cell 10 in an energized state and drives the water circulation pump 16. This initiates the generation of oxygen and hydrogen. The control unit 43 instructs the sensor unit 30 to measure the concentration. The concentration here is the concentration of hydrogen contained in the oxygen atmosphere gas and the concentration of oxygen contained in the hydrogen atmosphere gas recovered from the water electrolysis cell 10. The control unit 43 acquires information indicating the concentration from the sensor unit 30 via the communication unit 41. The control unit 43 stores the acquired information indicating the concentration in the storage unit 42. The control unit 43 controls the water electrolysis cell 10 on the basis of the acquired information indicating the concentration. For example, when the concentration is equal to or greater than a predetermined threshold value, the control unit 43 determines that there is a possibility of the water electrolysis cell 10 being damaged and stops the generation of hydrogen and oxygen by the water electrolysis cell 10. In this case, the control unit 43 puts the power supply of the water electrolysis cell 10 in a disconnected state and stops the driving of the water circulation pump 16. In this case, the control unit 43 stops measurement of concentration by the sensor unit 30.

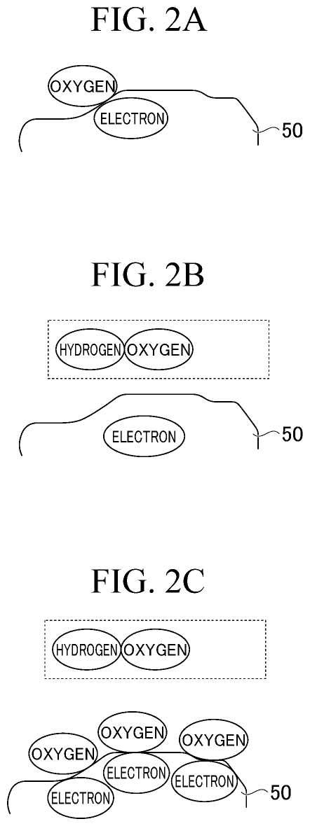

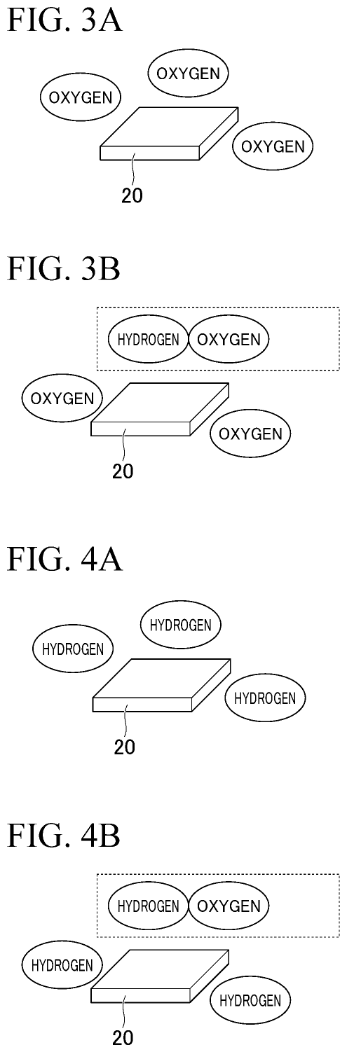

Here, the catalytic combustion type gas sensor 20 of the present embodiment will be described with reference to FIGS. 2A to 2C, FIGS. 3A and 3B, and FIGS. 4A and 4B. FIGS. 2A to 2C are diagrams illustrating a detection method using a general gas sensor used in a leak test. FIGS. 3A and 3B and FIGS. 4A and 4B are diagrams for explaining the detection method by the catalytic combustion type gas sensor 20 of the present embodiment.

Generally, a gas sensor used in a leak test or the like is used for the purpose of detecting the concentration of an inspection gas (for example, hydrogen) leaked into an atmosphere (for example, in the air). Such a gas sensor includes, for example, a gas sensor using a semiconductor 50 (semiconductor gas sensor).

As shown in FIG. 2A, the semiconductor gas sensor is mainly composed of a semiconductor 50 (for example, SnO₂, tin oxide). In a situation where the detection target gas (hydrogen) does not exist in the atmosphere, oxygen is adsorbed on the semiconductor 50 (SnO₂, tin oxide), and the adsorbed oxygen captures electrons of the semiconductor 50. Therefore, in the semiconductor gas sensor, it is difficult for electrons to move freely inside the semiconductor 50 in a situation where the detection target gas does not exist. Accordingly, the semiconductor 50 is in a state in which electricity does not easily flow even when a voltage is applied.

As shown in FIG. 2B, when the detection target gas (hydrogen) is present in the atmosphere, the hydrogen, which has a strong reducing property, binds with the oxygen. As a result, the oxygen is separated from the semiconductor 50, and electrons can move freely inside the semiconductor 50. Therefore, when a voltage is applied to the semiconductor 50, the semiconductor 50 enters an energized state. It is possible to measure the concentration of the detection target gas (hydrogen) based on the amount of current in the energized state.

However, when there is a large amount of oxygen in the atmosphere, that is, in the oxygen atmosphere gas, the semiconductor gas sensor cannot perform accurate measurement.

As shown in FIG. 2C, when there is a large amount of oxygen in the atmosphere, that is, in the oxygen atmosphere gas, even if the detection target gas (hydrogen) takes away an oxygen adsorbed on the semiconductor 50, another oxygen in the atmosphere is immediately adsorbed on the semiconductor 50. Therefore, in the semiconductor gas sensor, in the oxygen atmosphere gas, even when the detection target gas is present, the electrons are not able to move freely inside the semiconductor 50. Therefore, even when the detection target gas is present in the semiconductor 50, the state in which electricity does not easily flow continues even if a voltage is applied, which makes accurate measurement difficult. Therefore, it is difficult for a semiconductor gas sensor used in a general leak test to accurately detect the concentration of a trace amount of hydrogen contained in high-concentration oxygen.

On the other hand, the catalytic combustion type gas sensor 20 outputs an electric signal corresponding to the combustion heat (reaction heat) generated when there is combustion (hydrogen and oxygen react). For this reason, even in an oxygen atmosphere gas, it is possible to measure the gas concentration without deterioration as compared with the accuracy of the measurement in the air.

As shown in FIG. 3A, when hydrogen is not present in the oxygen atmosphere gas, there is no reaction in the catalytic combustion type gas sensor 20 even if the catalyst layer is heated by the heater and combustion is promoted, and therefore no reaction heat is generated. Therefore, no change in the thermopile output is detected according to the reaction heat.

As shown in FIG. 3B, when hydrogen is present in the oxygen atmosphere gas, when the catalyst layer is heated by the heater and combustion is promoted in the catalytic combustion type gas sensor 20, the hydrogen reacts with oxygen, and reaction heat is generated. A change in the thermopile output according to the reaction heat is then detected.

As shown in FIG. 4A, when oxygen is not present in the hydrogen atmosphere gas, there is no reaction in the catalytic combustion type gas sensor 20 even if the catalyst layer is heated by the heater and combustion is promoted, and therefore no reaction heat is generated. Therefore, no change in the thermopile output is detected according to the reaction heat.

As shown in FIG. 4B, when oxygen is present in the hydrogen atmosphere gas, when the catalyst layer is heated by the heater and combustion is promoted in the catalytic combustion type gas sensor 20, the oxygen reacts with hydrogen and reaction heat is generated. A change in the thermopile output according to the reaction heat is detected.

That is, by using the catalytic combustion type gas sensor 20 of the present embodiment, the concentration of hydrogen contained in an oxygen atmosphere gas can be measured even when the atmosphere is different from that of air and is filled with a high concentration of oxygen. Further, the concentration of oxygen contained in a hydrogen atmosphere gas can be measured even when the atmosphere is filled with a high concentration of hydrogen.

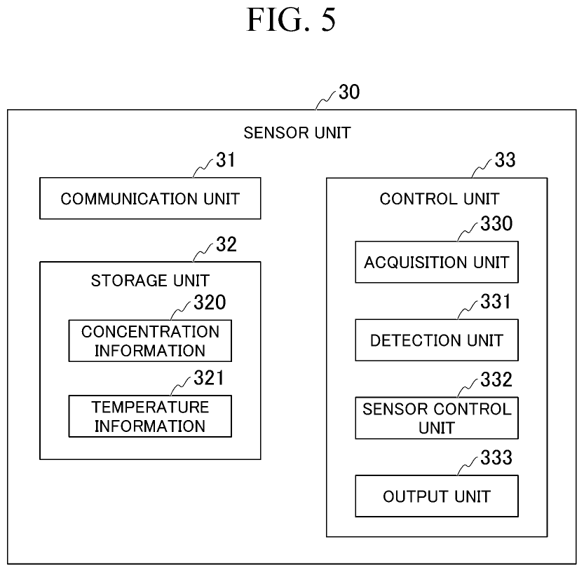

FIG. 5 is a block diagram showing a configuration example of the sensor unit 30 of the embodiment. The sensor unit 30 includes a communication unit 31, a storage unit 32, and a control unit 33. The communication unit 31 communicates with the catalytic combustion type gas sensor 20 and the management device 40. The communication unit 31 is realized by, for example, a general-purpose communication IC. The communication unit 31 has a function of communicating with an external network and transmitting/receiving information with the management device 40 or the like.

The storage unit 32 is, for example, a non-volatile memory, and stores programs and variables for realizing the functions of the sensor unit 30. Concentration information 320 and temperature information 321 are stored in the storage unit 32. The concentration information 320 is information about concentration used for controlling the measurement by the catalytic combustion type gas sensor 20. The concentration information 320 is, for example, information about concentration serving as a threshold value for lowering the temperature of the heater of the catalytic combustion type gas sensor 20 or for stopping the heater. The temperature information 321 is information about temperature used for controlling the measurement by the catalytic combustion type gas sensor 20. The temperature information 321 is, for example, information about temperature serving as a threshold value for lowering the temperature of the heater of the catalytic combustion type gas sensor 20 or for stopping the heater.

The control unit 33 comprehensively controls the sensor unit 30. The control unit 33 is composed of, for example, a CPU provided in the sensor unit 30. The control unit 33 realizes the functions of each unit of the sensor unit 30 by executing the program stored in the storage unit 32. More specifically, the control unit 33, which may be a processor, is configured to execute the instructions stored in the storage unit 32, which may be a memory, to realize the functions of each unit of the sensor unit 30. The control unit 33 includes, for example, an acquisition unit 330, a detection unit 331, a sensor control unit 332, and an output unit 333.

The acquisition unit 330 acquires a command indicating start or stop of measurement from the management device 40 via the communication unit 31. The acquisition unit 330 outputs the acquired command to the sensor control unit 332. Further, the acquisition unit 330 acquires an electrical signal output from the catalytic combustion type gas sensor 20 via the communication unit 31. The acquisition unit 330 outputs the acquired electrical signal to the detection unit 331.

The detection unit 331 derives the concentration of hydrogen contained in the oxygen atmosphere gas recovered from the water electrolysis cell 10 or the concentration of oxygen contained in the hydrogen atmosphere gas recovered from the water electrolysis cell 10 based on the electrical signal output from the catalytic combustion type gas sensor 20. The detection unit 331 acquires the electrical signal output from the catalytic combustion type gas sensor 20-1 via the communication unit 31. The detection unit 331 converts the amplitude of the acquired electrical signal to the hydrogen concentration. The detection unit 331 acquires the electrical signal output from the catalytic combustion type gas sensor 20-2 via the communication unit 31. The detection unit 331 converts the amplitude of the acquired electrical signal to the oxygen concentration. The detection unit 331 outputs information indicating the converted concentration to the sensor control unit 332 and the output unit 333. Each of the acquisition unit 330, the detection unit 331, the sensor control unit 332, and the output unit 333 is a function of the control unit 33 realized by the CPU.

The relationship between the amplitude of the electrical signal output from the catalytic combustion type gas sensor 20 and the concentration is determined by the combination of the sensor and the detection target gas, and is stored in, for example, the storage unit 32. The detection unit 331 refers to the storage unit 32. Thereby, the detection unit 331 acquires information indicating the relationship between the amplitude of the electrical signal and the concentration (for example, a conversion table, a proportional coefficient, a bias value, or the like). The detection unit 331 derives the concentration from the amplitude of the electrical signal by using the acquired information.

The sensor control unit 332 controls the catalytic combustion type gas sensor 20. Upon acquiring from the acquisition unit 330 a command indicating measurement start from the management device 40, the sensor control unit 332 supplies a drive current to the heater of the catalytic combustion type gas sensor 20 to start the measurement. Upon acquiring from the acquisition unit 330 a command indicating measurement stop from the management device 40, the sensor control unit 332 stops the drive current supplied to the heater of the catalytic combustion type gas sensor 20 and stops the measurement.

When the sensor control unit 332 acquires from the detection unit 331 information indicating the concentration, the sensor control unit 332 compares the acquired concentration with a predetermined threshold value. The predetermined threshold value is, for example, a value corresponding to a concentration that reduces the drive current supplied to the heater in order to suppress an increase in the temperature of the catalytic combustion type gas sensor 20. The predetermined threshold value is, for example, the concentration information 320 stored in the storage unit 32. When the acquired concentration is equal to or higher than a predetermined threshold value, the sensor control unit 332 performs control to reduce the drive current supplied to the heater so that the temperature of the catalytic combustion type gas sensor 20 does not rise. When the predetermined threshold value described above is a value corresponding to the concentration at which the drive current supplied to the heater is stopped, the sensor control unit 332 stops the drive current supplied to the heater if the acquired concentration is equal to or higher than the predetermined threshold value.

The output unit 333 transmits information indicating the concentration from the detection unit 331 as a detection value to the management device 40 via the communication unit 31.

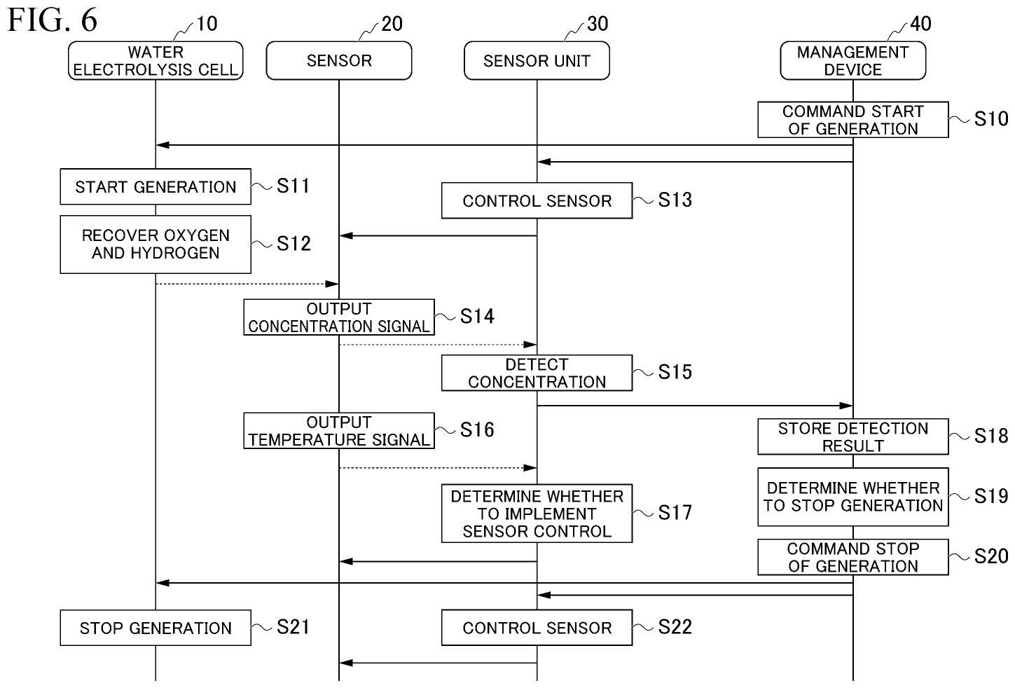

FIG. 6 is a sequence diagram illustrating the flow of processing performed by the gas generation system 1 of the embodiment. With reference to FIG. 6, the flow of processing from the start to the stop of the generation of oxygen and hydrogen will be described.

First, the management device 40 commands the start of hydrogen and oxygen generation (Step S10). The management device 40 puts the power supply of the water electrolysis cell 10 in an energized state and drives the water circulation pump 16. The management device 40 instructs the sensor unit 30 to start measurement of concentration.

In the water electrolysis cell 10, water is electrolyzed and the generation of hydrogen and oxygen is started (Step S11). The generated oxygen atmosphere gas is recovered through the oxygen path 18, and the generated hydrogen atmosphere gas is recovered through the hydrogen path 19 (Step S12).

Upon receiving the command to start measurement of concentration, the sensor unit 30 controls the catalytic combustion type gas sensor 20 to start the measurement (Step S13). The sensor unit 30 supplies a drive current to the heater of the catalytic combustion type gas sensor 20 and starts measurement of concentration by the catalytic combustion type gas sensor 20.

The catalytic combustion type gas sensor 20 outputs an electrical signal (concentration signal) corresponding to the concentration of the detection target gas to the sensor unit 30 (Step S14). The catalytic combustion type gas sensor 20-1 outputs a concentration signal of the hydrogen in the oxygen path 18. The catalytic combustion type gas sensor 20-2 outputs a concentration signal of the oxygen in the hydrogen path 19.

The sensor unit 30 detects the concentration (Step S15). The sensor unit 30 detects the concentration according to the amplitude of the concentration signal acquired from the catalytic combustion type gas sensor 20, and transmits a signal indicating the detected concentration to the management device 40.

The catalytic combustion type gas sensor 20 measures the temperature of the catalytic combustion type gas sensor 20 and outputs an electrical signal (temperature signal) indicating the measured temperature to the sensor unit 30 (Step S16).

The sensor unit 30 determines whether or not to control the catalytic combustion type gas sensor 20 (Step S17). The sensor unit 30 detects the temperature according to the amplitude of the temperature signal acquired from the catalytic combustion type gas sensor 20, and compares the detected temperature with a predetermined threshold value. The sensor unit 30 makes a determination to control the catalytic combustion type gas sensor 20 when the detected temperature is equal to or higher than the predetermined threshold value. The sensor unit 30 performs control according to the content of the control corresponding to the compared threshold value. The content of the control is, for example, reducing or stopping the drive current supplied to the heater of the catalytic combustion type gas sensor 20.

The management device 40 stores the detection result received from the sensor unit 30 (Step S18). The management device 40 determines whether or not to stop the generation of hydrogen and oxygen (Step S19). The management device 40 compares the detected concentration with a predetermined threshold value using the detection result. If the detected concentration is equal to or higher than the predetermined threshold value, the management device 40 determines that there is a possibility of the water electrolysis cell 10 being damaged, and makes a determination to stop the generation of hydrogen and oxygen.

Upon making a determination to stop the generation of hydrogen and oxygen, the management device 40 commands the stoppage of the generation of hydrogen and oxygen (Step S20). The management device 40 turns off the power supply of the water electrolysis cell 10 and stops the drive of the water circulation pump 16. The management device 40 instructs the sensor unit 30 to end measurement of concentration.

In the water electrolysis cell 10, the electrolysis of water is stopped, and the generation of hydrogen and oxygen is stopped (Step S21). The sensor unit 30 stops the drive current supplied to the heater of the catalytic combustion type gas sensor 20 and ends measurement of concentration by the catalytic combustion type gas sensor 20 (Step S22).

As described above, the gas concentration detection method of the embodiment is a gas concentration detection method executed by the gas generation system 1, the water electrolysis cell 10 generates hydrogen and oxygen by water electrolysis, and detects the oxygen concentration in the hydrogen path 19 or the hydrogen concentration in the oxygen path 18 by the catalytic combustion type gas sensor 20 disposed in at least one of the hydrogen path 19 for recovering the hydrogen and the oxygen path 18 for recovering the oxygen. Thereby, the gas concentration detecting method of the embodiment can detect oxygen leaked into the hydrogen generated by utilizing water electrolysis when a high concentration of hydrogen flows through the hydrogen path 19. Further, the gas concentration detecting method of the embodiment can detect the concentration of hydrogen leaked into the oxygen generated by utilizing water electrolysis when a high concentration of oxygen flows through the oxygen path 18.

The gas concentration detection method of the embodiment detects in the hydrogen path 19 the oxygen concentration in a gas in which 99.999% or less hydrogen and 10 ppm or more of oxygen are mixed. Alternatively, in the hydrogen path 19, the oxygen concentration in a gas in which 99% or more hydrogen and 1% or less oxygen are mixed is detected. This makes it possible to detect the concentration of a very small amount of oxygen contained in a hydrogen atmosphere gas through which high-concentration hydrogen flows.

Further, the gas concentration detection method of the embodiment detects in the oxygen path 18 the hydrogen concentration in a gas in which 99.999% or less oxygen and 10 ppm or more of hydrogen are mixed. Alternatively, in the oxygen path 18, the hydrogen concentration in a gas in which 99% or more oxygen and 1% or less hydrogen are mixed is detected. This makes it possible to detect the concentration of a very small amount of hydrogen contained in an oxygen atmosphere gas through which high-concentration oxygen flows.

Further, in the gas concentration detection method of the embodiment, the sensor unit 30 controls the catalytic combustion type gas sensor 20 on the basis of the oxygen concentration in the hydrogen path 19 or the hydrogen concentration in the oxygen path 18 detected by the catalytic combustion type gas sensor 20. As a result, it is possible to take measures such as lowering the temperature of the heater of the catalytic combustion type gas sensor 20 when there is concern about an ignited explosion due to the heater depending on the concentration detected by the catalytic combustion type gas sensor 20.

Further, the sensor unit 30 of the embodiment includes the detection unit 331 and the sensor control unit 332. The detection unit 331 detects the oxygen concentration in the hydrogen path 19 or the hydrogen concentration in the oxygen path 18 by the catalytic combustion type gas sensor 20 disposed in at least one of the hydrogen path 19 for recovering hydrogen and the oxygen path 18 for recovering oxygen, in hydrogen and oxygen generated by using water electrolysis. The sensor control unit 332 controls the catalytic combustion type gas sensor 20 on the basis of the oxygen concentration in the hydrogen path 19 or the hydrogen concentration in the oxygen path 18 detected by the detection unit 331. As a result, the same effect as the above-mentioned effect is obtained.

In the sensor unit 30 of the embodiment, the sensor control unit 332 stops concentration detection by the catalytic combustion type gas sensor when the oxygen concentration in the hydrogen path 19 or the hydrogen concentration in the oxygen path 18 detected by the detection unit 331 is equal to or higher than a predetermined threshold value. As a result, when the concentration of the detection target gas is high and the temperature of the catalytic combustion type gas sensor 20 rises due to the reaction heat such that there is a possibility of damage, the concentration detection can be stopped. Accordingly, damage can be suppressed.

The gas generation system 1 of the embodiment includes a water electrolysis cell 10, a sensor unit 30, and a management device 40. The water electrolysis cell 10 generates hydrogen and oxygen by water electrolysis. The sensor unit 30 detects the oxygen concentration in the hydrogen path 19 or the hydrogen concentration in the oxygen path 18 using a catalytic combustion type gas sensor 20. The management device 40 controls the water electrolysis cell 10 on the basis of the oxygen concentration or the hydrogen concentration detected by the sensor unit 30. As a result, the oxygen concentration of the hydrogen atmosphere gas and the hydrogen concentration of the oxygen atmosphere gas generated by the water electrolysis can be constantly detected. Therefore, it is possible to detect a sign that high-concentration hydrogen and high-concentration oxygen are mixed due to damage of the water electrolysis cell 10. Moreover, since the management device 40 controls the water electrolysis cell 10 according to the concentration detected by the sensor unit 30, when damage to the water electrolysis cell 10 is detected, it is possible to take measures such as stopping the water electrolysis cell 10.

In the description of the embodiments of the present invention, concentration means volume percent concentration, and “%” means “vol %”.

All or some of the gas generation system 1, the sensor unit 30, and the management device 40 in the above-described embodiment may be realized by a computer. In this case, programs for realizing these functions may be recorded on a computer-readable recording medium, and the program recorded on the recording medium may be read and executed by a computer system. It should be noted that the term “computer system” as used herein includes an OS and hardware components such as peripheral devices. Further, “computer-readable recording medium” refers to a portable medium such as a flexible disk, a magneto-optical disk, a ROM, or a CD-ROM, or to a storage device such as a hard disk built in a computer system. Further, a “computer-readable recording medium” may also include a medium that dynamically holds the program for a short period of time, such as a communication wire for transmitting the program over a network such as the Internet or a communication line such as a telephone line, or a recording medium that holds the program for a certain period of time, such as a volatile memory inside a computer system serving as a server or a client in such a case. Further, the above program may be a program for realizing some of the above-described functions, may be a program capable of realizing the above-described functions in combination with a program previously recorded in a computer system, and may be a program capable of being realized using a programmable logic device such as an FPGA.

According to the disclosure of the present invention, it is possible to measure the concentration of hydrogen leaked into oxygen generated using water electrolysis or the concentration of oxygen leaked into hydrogen generated using water electrolysis.

Although some embodiments of the present invention have been described, these embodiments are presented as examples and are not intended to limit the scope of the invention. These embodiments can be implemented in various other forms, and various omissions, substitutions, and changes can be made without departing from the gist of the invention. These embodiments and modifications thereof are included in the scope and gist of the invention, as well as in the scope of the invention described in the claims and the equivalent scope thereof.

The present invention may be applied to a gas concentration detection method, a gas concentration detection device, and a gas generation system.

What is claimed is:

1. A gas concentration detection method comprising:
generating hydrogen and oxygen by water electrolysis; and
detecting, by a catalytic combustion type gas sensor, an oxygen concentration in a hydrogen path for recovering the hydrogen or a hydrogen concentration in an oxygen path for recovering the oxygen, the catalytic combustion type gas sensor being arranged in at least one of the hydrogen path and the oxygen path.

2. The gas concentration detection method according to claim 1, wherein the catalytic combustion type gas sensor is arranged in the hydrogen path, and the catalytic combustion type gas sensor detects an oxygen concentration in a gas in which hydrogen having a concentration of 99.999% or less and oxygen having a concentration of 10 ppm or more are mixed in the hydrogen path.

3. The gas concentration detection method according to claim 1, wherein the catalytic combustion type gas sensor is arranged in the hydrogen path, and the catalytic combustion type gas sensor detects an oxygen concentration in a gas in which hydrogen having a concentration of 99% or more and oxygen having a concentration of 1% or less are mixed in the hydrogen path.

4. The gas concentration detection method according to claim 1, wherein the catalytic combustion type gas sensor is arranged in the oxygen path, and the catalytic combustion type gas sensor detects a hydrogen concentration in a gas in which oxygen having a concentration of 99.999% or less and hydrogen having a concentration of 10 ppm or more are mixed in the oxygen path.

5. The gas concentration detection method according to claim 1, wherein the catalytic combustion type gas sensor is arranged in the oxygen path, and the catalytic combustion type gas sensor detects the hydrogen concentration in a gas in which oxygen having a concentration of 99% or more and hydrogen having a concentration of 1% or less are mixed in the oxygen path.

6. The gas concentration detection method according to claim 1, further comprising:
controlling measurement of concentration by the catalytic combustion type gas sensor based on the detected oxygen concentration or the detected hydrogen concentration.

7. A gas concentration detection device comprising:
at least one memory configured to store instructions; and
at least one processor configured to execute the instructions to:
detect, using a catalytic combustion type gas sensor, an oxygen concentration in a hydrogen path for recovering hydrogen generated by water electrolysis or a hydrogen concentration in an oxygen path for recovering oxygen generated by water electrolysis, the catalytic combustion type gas sensor being arranged in at least one of the hydrogen path and the oxygen path; and
control measurement of concentration by the catalytic combustion type gas sensor based on the detected oxygen concentration or the detected hydrogen concentration.

8. The gas concentration detection device according to claim 7, wherein the at least one processor is configured to execute the instructions to stop the measurement of concentration by the catalytic combustion type gas sensor when the detected oxygen concentration or the detected hydrogen concentration is equal to or higher than a predetermined threshold value.

9. A gas generation system comprising:
the gas concentration detection device according to claim 7;
a water electrolysis cell configured to generate the hydrogen and the oxygen by water electrolysis, supply the hydrogen to the hydrogen path, and supply the oxygen to the oxygen path; and
a management device that comprises:
at least one memory configured to store second instructions; and
at least one processor configured to execute the second instructions to control generation of hydrogen and oxygen by the water electrolysis cell based on the detected oxygen concentration or the detected hydrogen concentration.
